(19) United States
(12) Patent Application Publication
(10) Pub. No.: US 2014/0311348 A1
(43) Pub. Date: Oct. 23, 2014

(54) HOUSING-TUBULAR MODULE OF HYDRIDE THERMAL SORPTION HYDROGEN SEPARATOR-COMPRESSOR

(71) Applicants: Yuli Kivovich Baichtok, Moscow (RU); Alexandr Konstantinovich Avetisov, Moscow (RU); Yury Mikhailovich Baranov, Balashikha Moskovskaya obl. (RU); Raushan Gumerovich Telyashev, Moscow (RU); Vladimir Zalmanovich Mordkovich, Moscow (RU); Sergey Vyacheslavovich Suvorkin, Elektrostal Moskovskaya obl. (RU); Anna Nikolaevna Obryvalina, Moscow (RU); Nataliya Vladimirovna Dudakova, Moscow (RU); Gennady Vladimirovich Kosarev, Moscow (RU); Nikolai Anatolievich Kostikov, Moscow (RU)

(72) Inventors: Yuli Kivovich Baichtok, Moscow (RU); Alexandr Konstantinovich Avetisov, Moscow (RU); Yury Mikhailovich Baranov, Balashikha Moskovskaya obl. (RU); Raushan Gumerovich Telyashev, Moscow (RU); Vladimir Zalmanovich Mordkovich, Moscow (RU); Sergey Vyacheslavovich Suvorkin, Elektrostal Moskovskaya obl. (RU); Anna Nikolaevna Obryvalina, Moscow (RU); Nataliya Vladimirovna Dudakova, Moscow (RU); Gennady Vladimirovich Kosarev, Moscow (RU); Nikolai Anatolievich Kostikov, Moscow (RU)

(21) Appl. No.: 14/130,302

(22) PCT Filed: Jun. 29, 2012
(86) PCT No.: PCT/RU2012/000522

§ 371 Date: Jun. 27, 2014

(30) Foreign Application Priority Data
Jul. 4, 2011 (RU) 2011127136

(51) Int. Cl. B01D 53/04

(52) U.S. Cl. CPC B01D 53/0407
USPC 96/133

(57) ABSTRACT

A horizontal housing-tubular module of a hydride thermal sorption hydrogen separator-compressor comprising a housing with tubular sorption elements made in the form of a cylinder filled with hydrogen sorbent based on intermetallic compounds that form reversible hydrides, and a porous tubular gas distribution device. The tubular sorption elements comprise an inner cylinder. The hydrogen sorbent is located in the annular space between the inner and outer cylinders, and the porous tubular gas distribution device is made in the form of tubes with one end plugged. The tubes are located in the top and bottom section of the sorption element for supplying a gas mixture and removing hydrogen and residual gas. The tubes are connected with tube collectors. The invention makes it possible to create a high-output housing-tubular module of a hydride thermal sorption hydrogen separator-compressor producing pure hydrogen at positive pressure.

### CROSS-REFERENCE TO RELATED APPLICATION

This application is a national stage application and claims the benefit of the priority filing date in PCT/RU2012/000522 referenced in WIPO Publication WO 2013/006091 filed on Jun. 29, 2012. The earliest priority date claimed is Jul. 4, 2011.

### FEDERALLY SPONSORED RESEARCH

Not Applicable

### SEQUENCE LISTING OR PROGRAM

Not Applicable

### BACKGROUND

The claimed invention relates to chemical engineering and specifically to devices for extraction of hydrogen from gas mixtures with simultaneous compression of hydrogen by using reversible hydrides of intermetallic compounds. Hydrogen absorption from a gas mixture is performed by forming an intermetallic compound hydride and removing reaction heat at 20-50° C. Pure hydrogen is produced at positive pressure during hydride decomposition due to heat supply at 85-130° C.

The device can be used in chemical, petrochemical, electronic and food industries, and in metallurgy.

The device prototype is the hydrogen storage apparatus per USSR Certificate of Authorship No. 1837694, 09.24.1970, Cl. F17c 11/00. That invention represents a horizontal housing-tubular apparatus comprising a housing with tubular sorption elements filled with powdered intermetallic compounds-based hydrogen sorbent. In the top and bottom section of each element along its length there are porous tubular gas distribution devices. The gas distribution devices extend beyond the sorption elements and are bundled into tube collectors. A cold and hot heat transfer agent is supplied periodically during hydrogen sorption and desorption, respectively, into the intertubular space between the housing and the outer surface of the tubular sorption elements.

The prototype technical solution has some serious disadvantages resulting in reduced output and higher cost of the apparatus. Between 70% and 90% of the cost of a hydride thermal sorption hydrogen separator-compressor is determined by the cost of the intermetallic compound in it; therefore, reduction of the cycle time of switching sorption modules is practically proportional to the reduction of unit capital expenditures or to output increase.

The process of hydride formation is accompanied by a significant thermal effect, ˜6.5-7 kcal/mol H2. So the limit-setting stage of the hydrogen sorption process is the rate of heat transfer in the sorbent layer. Thus, the length of the sorption-desorption cycle is determined by the rate of heat transfer in the sorbent layer which depends on sorbent layer thickness. In the tubular sorption module design offered in the prototype, layer thickness is equal to one-half of the tubular module inside diameter.

The object of the claimed invention is to reduce apparatus cost while increasing output. The object is achieved by increasing the rate of heat transfer by reducing the thickness of the sorption layer while using the same volume of sorbent per unit of length of the sorption element. This is achieved by making a tubular sorption element in the form of coaxial cylinders, with sorbent placed in the annular space between them.

### SUMMARY

The invention relates to power generation and chemical engineering, and can be used in chemical, petrochemical, electronic and food industries, in metallurgy and in other industries. The invention is horizontal housing-tubular module of a hydride thermal sorption hydrogen separator-compressor comprising a housing with tubular sorption elements made in the form of a cylinder filled with hydrogen sorbent based on intermetallic compounds that form reversible hydrides, and a porous tubular gas distribution device. The tubular sorption elements comprise an inner cylinder. The hydrogen sorbent is located in the annular space between the inner and outer cylinders, and the porous tubular gas distribution device is made in the form of tubes with one end plugged. The tubes are located in the top and bottom section of the sorption element for supplying a gas mixture and removing hydrogen and residual gas. The tubes are connected with tube collectors. The invention makes it possible to create a high-output housing-tubular module of a hydride thermal sorption hydrogen separator-compressor producing pure hydrogen at positive pressure.

### DRAWINGS

FIG. 1 is a side view of a horizontal housing-tubular module of a hydride thermal sorption hydrogen separator-compressor.

FIG. 2 is a cross-sectional view of the horizontal housing-tubular module.

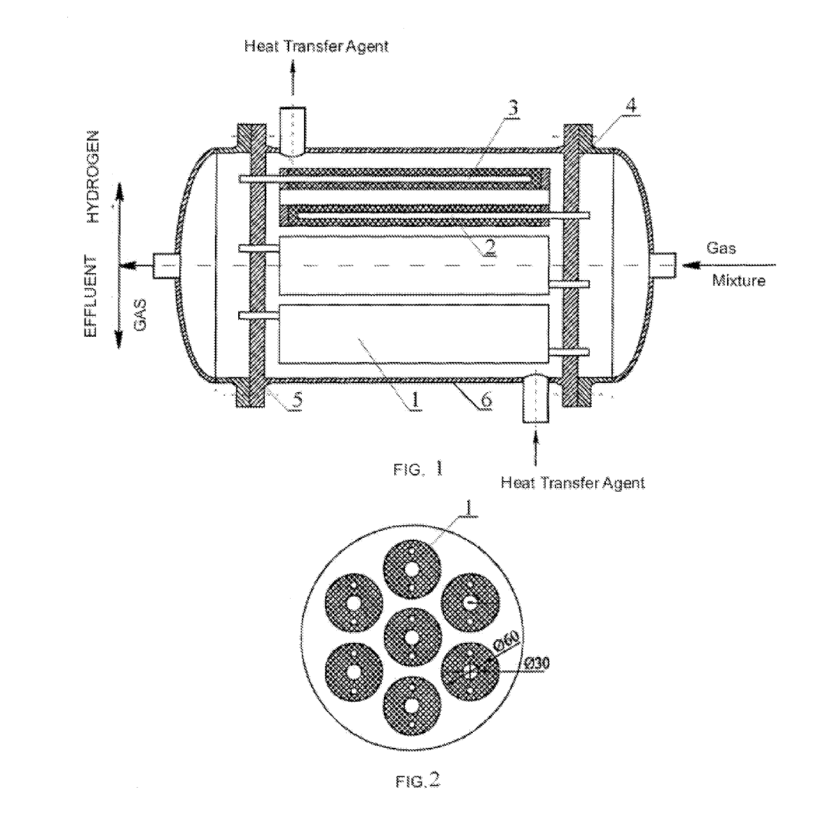

### BRIEF DESCRIPTION OF THE INVENTION

The horizontal sorption module comprises seven tubular sorption elements 1; inside each element there are two porous tubular gas distribution devices 2 and 3 extended into gas collectors through tube plates 4 and 5. The sorption elements are located inside the housing 6.

The tubular sorption element comprises an outer cylinder with a 60 mm inside diameter and an inner cylinder with a 30 mm outer diameter. An intermetallic compound is located in the annular space between the cylinders.

The thickness of the sorbent layer in the element is 15 mm, and has a volume of ˜212 cm3per 100 mm of the element length. Compare this, for instance, to the prototype sorption element with a 50 mm inside diameter and a 25 mm thick layer, with a volume of ˜196 cm3 per 100 mm of the element length.

Thus, at an equal temperature difference and specific thermal conductivity, the heat transfer rate and, hence, the apparatus output in the claimed invention are approximately 50% higher than in the prototype. Furthermore, the heat exchange surface in the inventive design solution is 80% larger than in the analogue which, all other things being equal, also increases apparatus output.

What is claimed:

1. A horizontal housing-tubular module of a hydride thermal sorption hydrogen separator-compressor comprising a housing with tubular sorption elements filled with hydrogen sorbent based on intermetallic compounds that form reversible hydrides, porous tubular gas distribution devices located in a top and bottom section of each tubular sorption element for feeding gas mixture and removing hydrogen and residual gas, and tube collectors, wherein each tubular sorption element is made in the form of coaxial cylinders with sorbent placed in an annular space between them.
